(19) United States
(12) Patent Application Publication
(10) Pub. No.: US 2017/0083942 A1
(43) Pub. Date: Mar. 23, 2017

(54) MANAGING ELECTRONIC OLFACTORY SYSTEMS

(71) Applicant: International Business Machines Corporation, Armonk, NY (US)

(72) Inventors: Yuk L. Chan, Rochester, NY (US); Michael D. Essenmacher, Danbury, CT (US); David B. Lection, Raleigh, NC (US); Eric L. Masselle, Wake Forest, NC (US)

(21) Appl. No.: 15/055,742

(22) Filed: Feb. 29, 2016

Related U.S. Application Data
(63) Continuation of application No. 14/861,103, filed on Sep. 22, 2015.

(51) Int. Cl. G06Q 30/02; H04W 4/00; H04L 29/08

(52) U.S. Cl. CPC G06Q 30/0255; H04L 67/22; H04W 4/008; G06Q 30/0257; G06Q 30/0261; G06Q 30/0265

(57) ABSTRACT

A computer-implemented method, system, and computer product for managing an electronic olfactory system in a mobile device configured to accept and deploy olfactory data. The method, system, and computer product identifies an advertising party using a mobile device in response to detecting the advertising party. The method, system, and computer product receives an advertising demand from the advertising party on the mobile device, the advertising demand comprises a first set of olfactory data and a request for emitting the first set of olfactory data and performs the advertising demand based on a user's preferences.

### BACKGROUND

The present disclosure relates generally to the field of computer systems for managing electronic olfactory systems.

The olfactory systems are generally the sensory systems used for olfaction, or the sense of smell. Electronic olfaction is the automated simulation of the sense of smell. It is an emerging application of modern science where robots or other automated systems are used to measure and/ or emit a particular chemical concentration in air. An electronic olfactory system generally includes gas sensor array instruments capable of detecting, identifying, emitting, and measuring volatile compounds. The successful design of a pattern analysis system for machine olfaction requires a careful consideration of the various issues involved in processing multivariate data: signal-preprocessing, feature extraction, feature selection, classification, regression, clustering, emitting measurements, and validation as well as foretelling or estimating the sensor response to aroma mixtures.

Electronic devices have become every popular. Even in emerging countries, most of the population carries a cell phone, or smart phone. As these devices evolve, more and more methods of interaction are being developed. The technology allowing olfactory sensing and output in computing devices (e.g. smart phones and other similar mobile devices) is now reaching maturity. Adding this capability will enable a device to both sense olfactory scents in the air, and to dynamically generate scents of all kinds for the user to enhance their sensory experiences.

Targeted advertising is a type of advertising whereby advertisements are placed so as to reach consumers based on various traits such as demographics, proximity, behavioral variables (such as product purchase history), or other second-order activities which serve as a proxy for these traits.

### SUMMARY

The present disclosure implements a computer-implemented system, method, and computer program product for managing an electronic olfactory system.

In an embodiment, a method for managing an electronic olfactory system, is provided. The method includes identifying an advertising party using a mobile device in response to detecting the advertising party. The method includes receiving an advertising demand from the advertising party on the mobile device. The advertising demand may include olfactory data and a request for emitting the olfactory data. The method includes performing the advertising demand based on a user's preferences. The method is performed on a mobile device which is configured to accept and deploy olfactory data.

In another embodiment, a computer program product for managing an electronic olfactory system is provided. The computer program product includes a computer-readable storage medium having program code embodied therewith, the program code executable by a processor of a computer to perform a method which includes identifying an advertising party using a mobile device in response to detecting the advertising party. The computer program product includes receiving an advertising demand from the advertising party on the mobile device. The advertising demand may include olfactory data and a request for emitting the olfactory data. The computer program product includes performing the advertising demand based on a user's preferences. The computer program product is performed on a mobile device which is configured to accept and deploy olfactory data.

In an embodiment, a computer system for managing an electronic olfactory system, is provided. The computer system includes one or more computer processors, one or more computer-readable storage media. The program instructions are stored on the computer-readable storage media for execution by at the one or more processors, the program instructions comprise instructions to identify an advertising party using a mobile device in response to instructions to detect the advertising party. The computer system includes instructions to receive an advertising demand from the advertising party on the mobile device. The advertising demand includes olfactory data and a request for emitting the olfactory data. The computer system includes instructions to perform the advertising demand based on a user's preferences. The computer system is performed on a mobile device which is configured to accept and deploy olfactory data.

### BRIEF DESCRIPTION OF THE SEVERAL VIEWS OF THE DRAWINGS

FIG. 1A is schematic block diagram depicting an exemplary computing environment for a managing olfactory program, in accordance with an aspect of the present disclosure.

FIG. 1B is as schematic block diagram depicting components of a managing olfactory program, in accordance with an aspect of the present disclosure.

FIG. 2 is a flowchart depicting operational steps of a method for a managing olfactory program, in accordance with an embodiment of the present disclosure.

FIG. 3 is a schematic block diagram depicting operations of a managing olfactory program, according to an embodiment of the present disclosure.

FIG. 4 is a block diagram of internal and external components of computers and servers depicted in FIG. 1, according an embodiment of the present disclosure.

### DETAILED DESCRIPTION

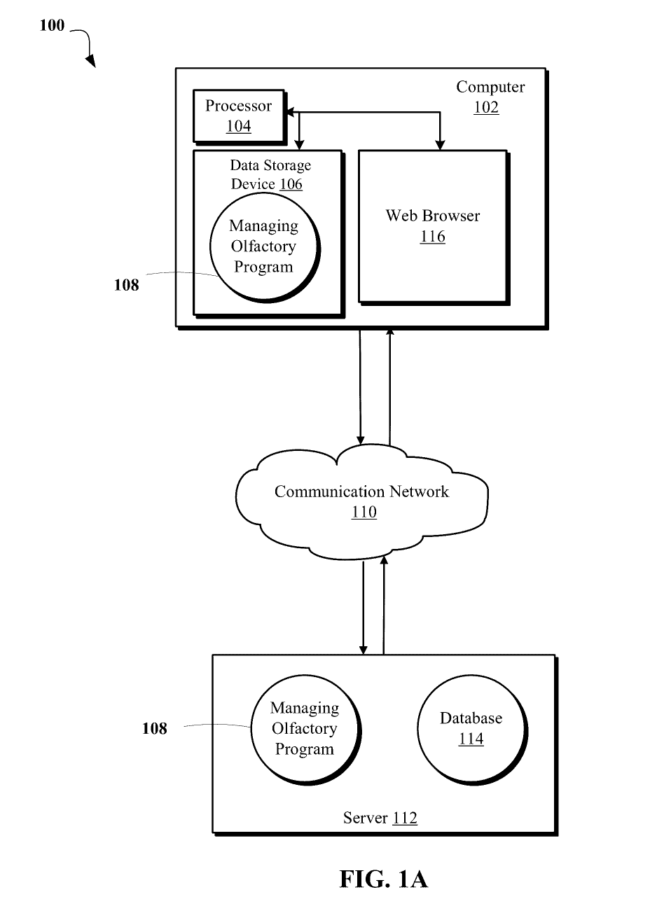

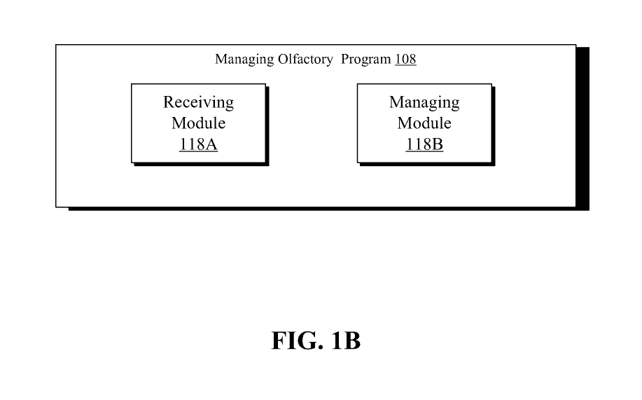

FIG. 1A depicts a computing environment 100 for managing the display of application forms within a web-based application. In various embodiments of the present disclosure, the computing environment 100 may include a computer 102 and server 112 connected over communication network 110.

A computer 102 may include a processor 104 and a data storage device 106 that is enabled to run a managing olfactory program 108 and a web browser 116 that may display an application form or a user interface for the user to work a managing olfactory program 108. Non-limiting examples of a web browser may include: Firefox®, Explorer®, or any other web browser. All brand names and/or trademarks used herein are the property of their respective owners.

The computing environment 100 may also include a server 112 with a database 114. The server 112 may be enabled to run a program such as a managing olfactory program 108. A communication network 110 may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Communication network 110 may also include a number of different types of networks, such as, for example, an intranet, a local area network (LAN), or a wide area network (WAN).

It should be appreciated that FIG. 1A provides only an illustration of one implementation and does not imply any limitations with regard to the environments in which different embodiments may be implemented. Many modifications to the depicted environments may be made based on design and implementation requirements.

The computer 102 may communicate with the server 112 via the communication network 110. The communication network 110 may include connections, such as wire, wireless communication links, or fiber optic cables.

The computer 102 and the server 112 may be, for example, a mobile device, a telephone, a personal digital assistant, a netbook, a laptop computer, a tablet computer, a desktop computer, or any type of computing device capable of running a program and accessing a network. A program, such as a managing olfactory program 108 may run on the computer 102 or on the server 112. It should be appreciated that managing olfactory program 108 has the same component and operation methods regardless of whether it is run on the server 112 or computer 102. Therefore managing olfactory program 108 applies to both managing olfactory program 108 run on a computer 102 and managing olfactory program 108 run on the server 112 are interchangeably used throughout this disclosure.

Referring now to FIG. 1B, different modules of managing olfactory program 108 are depicted. Managing olfactory program 108 comprises two modules of receiving module 118A and managing module 118B. Receiving module 118A may detect and identify an advertising party, receive an advertising demand, comprising of olfactory data and a request to emit that olfactory data. In addition, receiving module 118A may also collect user's preferences regarding advertising, conditions and scents. Managing module 118B may perform the advertising demand based on user's preferences.

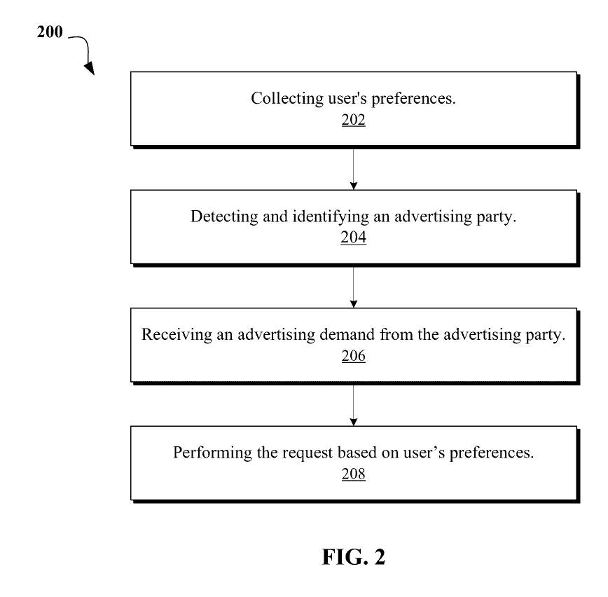

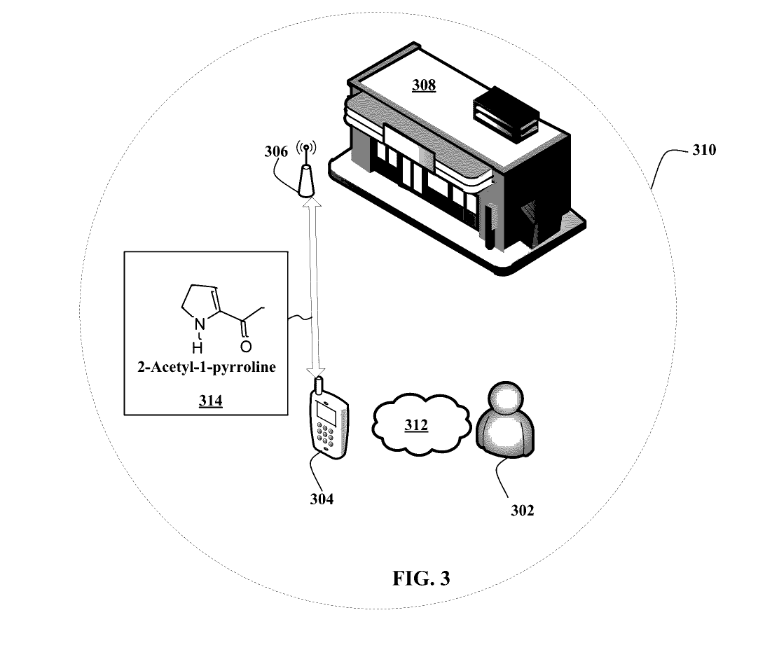

In reference to FIG. 2, steps of method 200, in conjunction with the depicted embodiment in FIG. 3, may be implemented using one or more modules of a computer program, for example, managing olfactory program 108, and executed by a processor of a computer, such as computer 102. It should be appreciated that FIG. 2 does not imply any limitations with regard to the environments or embodiments which may be implemented. Many modifications to the depicted environments or embodiments shown in FIG. 2 may be made.

At block 202, receiving module 118A may collect user's preferences. These preferences may comprise questions regarding advertising, targeted advertising, scents, health conditions, shopping habits, and taste. In an embodiment, the collection of preferences may pertain to types, categories of products, goods, and/or services advertisements a particular user may enjoy or be willing to receive. In another embodiment, receiving module 118A may provide user with a user interface in order to obtain information and preferences. In other embodiments, receiving module 118A may obtain permission to monitor user's online activities. Receiving module 118A may monitor user's online activities and detect references to certain landmarks, stores, or types of activities in order to determine user's preferences. For example, in that embodiment, if a user has visited a certain store's website or has purchased many items (e.g. satisfying a pre-determined threshold) from a store, receiving module 118A may detect a preference or affinity toward that store.

In the present embodiment, user 302, consents to a request by receiving module 118A to monitor user's 302 internet activities. User 302 regularly visits French bread-making and various French bakery and culinary websites. User 302 regularly talks about the difference between different types of baguettes and other French breads. Receiving module 118A, in the present embodiment, detects that user 302 does have a preference to receive targeted advertising from bakeries and in particular, French bakeries.

At block 204, receiving module 118A may detect and identify an advertising party. An advertising party is any party (e.g. company, person, entity, or organization) that advertises products or services and wishes to send a user a targeted advertisement. Targeted advertising is a type of advertising where advertisements are placed so as to reach consumers based on various traits such as demographics, proximity, preferences, psychographics, behavioral variables (such as product purchase history), or other activity. Non-limiting examples of an advertising party may comprise stores, businesses, online retailers, tourist attractions, restaurants, and any other entity or person with interest of advertising.

In one embodiment, receiving module 118A may detect an advertising party using a positioning methods such as a GPS device. GPS, which stands for Global Positioning System, is a radio navigation system that allows land, sea, and airborne users to determine their exact location, velocity, and time 24 hours a day, in all weather conditions, anywhere in the world. In that embodiment, receiving module 118A may use a GPS, configured on a mobile device carried by the user, to determine the whereabouts of the user and (based on a pre-determined threshold) the proximity of the user to different advertising parties. For example if the user is walking on a street, receiving module 118A may, in that embodiment, detect stores close to the user.

It must be mentioned that, as it is well-known in the art, GPS devices may not be accurate (or sometimes malfunction) in certain geographical locations such as inside buildings, or locations with high altitude. In an embodiment, receiving module 118A may detect such malfunctions and use other positioning/detection technologies even if the managing olfactory program 108 has been configured to detect the advertising party using a GPS.

In another embodiment, receiving module 118A may use NFC (Near Field Communication) in order to detect advertising parties. Near field communication (NFC) is the set of protocols that enables electronic devices to establish radio communication with each other by touching the devices together or bringing them into proximity to a predetermined distance. In that embodiment, user may bring his mobile device close to an established NFC field and receiving module 118A may detect the advertising party (if any) using the data transfer.

In another embodiment, receiving module 118A may use RFID (Radio-frequency identification) in order to detect an advertising party. RFID is the wireless use of electromagnetic fields to transfer data, for the purposes of automatically identifying and tracking RFID tags attached to objects. RFID tags contain electronically stored information. Some RFID tags are powered by electromagnetic induction from magnetic fields produced near the reader. Some types collect energy from the interrogating radio waves and act as a passive transponder. Other types have a local power source such as a battery and may operate within a certain geographical zone (e.g. radius of hundred feet from the REFID device). In that embodiment, user may bring his mobile device close to an established RFID zone (this may be accomplished by a user walking close to a store) and receiving module 118A may detect the advertising party (if any) using the data transfer.

In another embodiment, receiving module 118A may use a barcode to detect an advertising party. A barcode is an optical machine-readable representation of data relating to the object to which it is attached. Barcodes may be one-dimensional (e.g. varying the widths and spacing of parallel lines) or two-dimensional (e.g. rectangles, dots, hexagons, and other geometric patterns in two dimensions). Barcodes may be scanned by any reading device equipped with a scanner and interpreter device including mobile devices. In that embodiment, user may scan a barcode near a business or entity and receiving module 118A may detect the advertising party (if any) using the data transfer.

In another embodiment, receiving module 118A may use image recognition to detect an advertising party. Image recognition refers to electronically perceiving and understanding an image. Many existing methods are used to recognize images. In that embodiment, user may take a picture of a business or entity and receiving module 118A may detect the advertising party (if any).

Receiving module 118A may also identify the advertising party. Receiving module 118A may use the detected advertising party and identify it using a data bank. For example, Receiving module 118A may detect a restaurant using any of the above-mentioned methods and may also cross check the store's detected information against a data bank (which may be pre-loaded in the managing olfactory program 108 or an online data bank) in order to identify the detected restaurant.

In the present embodiment, user 302 is walking along a street. In the present embodiment, user 302 is carrying mobile device 304 (smart phone). Mobile device 304 is equipped with a managing olfactory program 108 and is configured to accept and deploy olfactory data by using a capsule holder of different chemicals which may emit various chemical compound yielding certain scents. In the present embodiment, user 302 walks by advertising party 308. Advertising party 308 is a French bakery and is equipped with a RFID device 306. RFID device 306 communicates with electronic devices within RFID zone 310. In the present embodiment, user 302 holding his mobile device 304, walks in the RFID zone 310. In the present embodiment, mobile device detects advertising party 308 by communicating through RFID device 306. Furthermore, mobile device 304 identifies advertising party 308 as a French bakery using a pre-loaded data bank which contains information regarding landmarks, businesses, and different advertising parties.

At block 206, receiving module 118A may receive an advertising demand form the advertising party. An Advertising demand which is generated by the advertising party or another third-party and may comprise olfactory data and a request to emit said olfactory data. Olfactory data may provide information regarding a certain scent detectable by an olfactory receptor. An olfactory data, may be an odorant, aroma, fragrance, or flavor, and may comprise a chemical compound yields a scent. A chemical compound yields a scent when it s sufficiently volatile to be transported to the olfactory receptor. A non-uniting example of an olfactory data is vanillin. Vanillin is the primary component of the extract of vanilla beans with a chemical compound of (C₈H₈O₃). Simply put, this is chemical compound could replicate the smell of vanilla. An advertising demand may also include a request to emit the olfactory data. It may also include other information such as the amount and the duration of emittance.

In the present embodiment, receiving module 118A receives advertising demand 314 from the advertising party 308 using RFID device 306. Advertising demand 314 comprises olfactory data for 2-Acetyl-1-Pyrroline. 2-Acetyl-1-pyrroline, is a chemical compound and aroma which replicates the scent of white bread. Advertising demand 314 comprises detailed instructions of how to emit 2-Aceytl-1-pyrroline by explaining its structural homolog of 6-acetyl-2,3,4,5-tetrahydropyridine and how it may be formed. Advertising demand 314, in the present embodiment, also includes a request to emit 2-Aceytl-1-pyrroline with a threshold of below 0.06 ng/l/s (Nano gram per liter per second).

At block 208, managing module 118B may perform the advertising demand based on user's preferences. Managing module 118B may user's preferences and perform, or change/manipulate the performance of the advertising demand. In an embodiment, managing module 118B may analyze the advertising demand and compare it to user's preferences. For example in that embodiment, if the user has indicated that the user is willing to accept olfactory advertisements from a category of items and if managing module 118B receives an advertising demand corresponding to said category of items, managing module 118B may perform the advertising demand.

It must be appreciated that in another embodiment, if the user's preferences is to not receive certain advertisements or to not receive certain scents, or scent from certain categories, managing module 118B may decline (by not performing) the advertising demand at all. For example in one embodiment, a user has indicated that the user suffers from diabetes and would like to inhibit acceptance any olfactory or other advertisements relating to sweets, candy, or bakeries. In that embodiment, managing module 118B upon receiving an advertising demand relating to chocolate, may not perform said advertising demand.

In another embodiment, managing module 118B may modify or emit another olfactory data instead of the received advertising demand in order to counteract an existing scent. In that embodiment, for example, if a user has indicated strong aversion towards the smell of tobacco, managing module 118B may emit a pleasant smell (based on user's preferences) when receiving an advertising demand relating tobacco.

In the present embodiment, managing module 118B analyzes user's 302 preferences and detects that user 302 has a strong affinity towards French culinary art and especially French baking. Managing module 118B performs the advertising demand by emitting chemical compound 312 which corresponds to advertising demand's olfactory data (2-Acetyl-1-pyrolline).

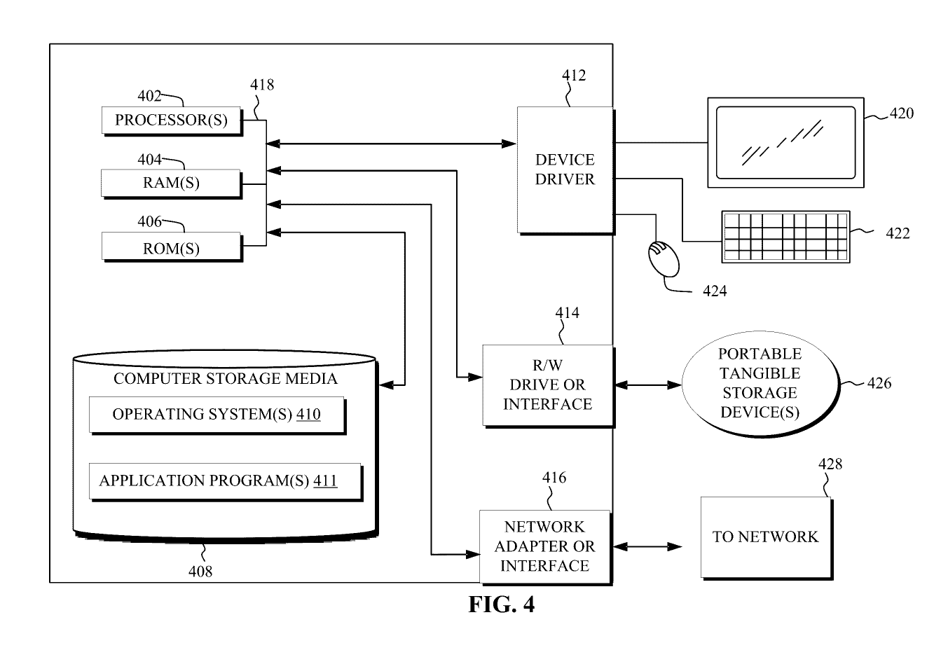

Referring now to FIG. 4 of components a computer system, for example server 112 and data source 120, of computing environment 100 of FIG. 1, in accordance with an embodiment of the present disclosure.

Server 112 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 112 and computer 102 may also include an R/W drive or interface 414 to read from and write to one or more portable computer readable storage media 426. Application programs 411 on server 112 and computer 102 may be stored on one or more of the portable computer readable storage media 426, read via the respective R/W drive or interface 414 and loaded into the respective computer readable storage media 408.

Server 112 may also include a network adapter or interface 416, such as a TCP/IP adapter card or wireless communication adapter (such as a 4G wireless communication adapter using OFDMA technology). Application programs 411 on server 112 and may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network 428 may comprise copper wires, optical fibers, wireless transmission, routers, firewalls, switches, gateway computers and/or edge servers.

Server 112 and computer 102 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

While the present invention is particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present disclosure. Therefore, the present disclosure has been disclosed by way of example and not limitation.

1. A computer-implemented method for managing an electronic olfactory system, comprising:
requesting permission from a user to monitor the user's online activity in order to detect user's preferences;
obtaining the permission;
monitoring, by a computer, the user's online activity;
determining, by the computer, the user's preferences towards an advertising party, the advertising party being any party that advertises products or services;
receiving RFID (Radio-frequency identification) signals from the advertising party, by a cell phone configured to accept and deploy a scent based on olfactory data when the user enters an RFID zone, the RFID zone comprising a radius of a hundred feet from the advertising party;
identifying the advertising party in response to receiving RFID signals, using the cell phone;
receiving an advertising demand from the advertising party on the cell phone, the advertising demand comprises a first scent based on a first set of olfactory data and a request for the mobile device to emit the first scent using RFID signals, wherein the first set of olfactory data provides information regarding the first scent detectable by an olfactory receptor;
declining the request of the advertising to emit the first scent demand based on a user's preference; and
in response to declining to emit the first scent, the cellphone emits a second scent based on a second set of olfactory data, based on the user's preference, wherein the second set of olfactory data provides information regarding the second scent; wherein the cellphone comprises a capsule holder of different chemicals which emits one or more chemical compounds to make the second scent based on the second set of olfactory data.
